(19) United States
(12) Patent Application Publication
(10) Pub. No.: US 2026/0231044 A1
(43) Pub. Date: Aug. 6, 2026

(54) WIRELESSLY ACTIVATED REMOTE DATA ACQUISITION

(71) Applicant: Interdisciplinary Consulting Corporation, Gainesville, FL (US)

(72) Inventors: Daniel D'Andrea, Gainesville, FL (US); William C. Patterson, Gainesville, FL (US); Rachel Collins, Gainesville, FL (US)

(21) Appl. No.: 19/364,435

(22) Filed: Oct. 21, 2025

Related U.S. Application Data
(60) Provisional application No. 63/753,613, filed on Feb. 4, 2025.

(51) Int. Cl. H04W 52/02; H04W 4/38

(52) U.S. Cl. CPC H04W 52/028; H04W 4/38

(57) ABSTRACT

A wirelessly activated data acquisition (DAQ) system, includes: a central controller including a wake-up link transmitter and a data link transceiver; and a data acquisition node including: a battery; a wake-up link receiver coupled to and powered by the battery; a power supply circuit controlled by a signal from the wake-up link receiver, the power supply circuit being coupled to the battery and the wake-up link receiver; a processor coupled to the power supply circuit to receive power under control of the signal from the wake-up link receiver; and a data link transceiver coupled to the processor, wherein the processor directs the data link transceiver to transmit data from one or more sensors coupled to the processor.

### CROSS-REFERENCE TO RELATED APPLICATION(S)

This application claims the benefit of U.S. Provisional Application No. 63/753,613, filed Feb. 4, 2025.

### GOVERNMENT SUPPORT

This invention was made with government support under contract number 80NSSC24PB345 awarded by NASA. The government has certain rights in the invention.

### BACKGROUND

Sensors are an important part of instrumentation in many environments. For example, for spacecraft, satellites, and launch vehicles, data concerning temperature, positioning, and other aspects of the environment and the vehicle is beneficial. To this end, various sensors may be included on or about the vehicles.

Wired instrumentation cabling contributes significantly to spacecraft weight and can be a source of failures and hazards since wired sensor placement can require cabin envelope bulkhead penetration. In addition, needing to route additional cabling for each new sensor can limit placement flexibility. Therefore, reducing the number of cables required for the sensors can be desirable. One approach to reducing the number of cables involves utilizing wireless sensors. However, wireless sensors can require their own means of power to at least support wireless transmission of instrument readings. While there continues to be efforts made for improving power efficiency and reduce power consumption, there still exists a need for sensors that can be used in environments in which replacement of the energy source is not possible or is not able to be accomplished for long periods of time.

### BRIEF SUMMARY

Wirelessly activated remote data acquisition (DAQ) is described in which the battery life of battery-operated wireless sensor nodes is able to be extended.

A wireless sensor node is provided that is suitable for spacecraft and other bodies where the need for data from the instrumentation is intermittent or not required for extended periods of time.

In some aspects, the techniques described herein relate to a data acquisition (DAQ) system, including: a central controller including a wake-up link transmitter and a data link transceiver; and a data acquisition node including: a battery; a wake-up link receiver coupled to and powered by the battery; a power supply circuit controlled by a signal from the wake-up link receiver, the power supply circuit being coupled to the battery and the wake-up link receiver; a processor coupled to the power supply circuit to receive power under control of the signal from the wake-up link receiver; and a data link transceiver coupled to the processor, wherein the processor directs the data link transceiver to transmit data from one or more sensors coupled to the processor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment of a wirelessly activated remote data acquisition system.

FIG. 2 shows a diagram of a wirelessly activated remote data acquisition system.

### DETAILED DESCRIPTION

Wirelessly activated remote data acquisition (DAQ) is described in which the battery life of battery-operated wireless sensor nodes is able to be extended.

Implementations of the described systems can be used aboard spacecraft for the purpose of collecting data from various sensors. In this manner, certain implementations are directed for use in space, including space travel. In some cases, the described systems can be used in remote stations that may be unoccupied or expected to be inactive for long periods of time.

The unique combination of electronics, sensors, and communications protocols described herein enable the electronics to remain powered down for extended periods of time while also remaining available for immediate on-demand power on.

Allowing portions of the electronics to remain completely powered down, especially more complex electronics such as microcontrollers and other wireless transceivers, means much greater immunity to harmful radiation events common aboard spacecraft. Additionally, allowing portions to remain powered down means a vast reduction in power consumption, which allows the system to operate from battery for a much longer period. An example implementation is designed to remain powered down for a period of up to 5 years while remaining available for immediate on-demand power on.

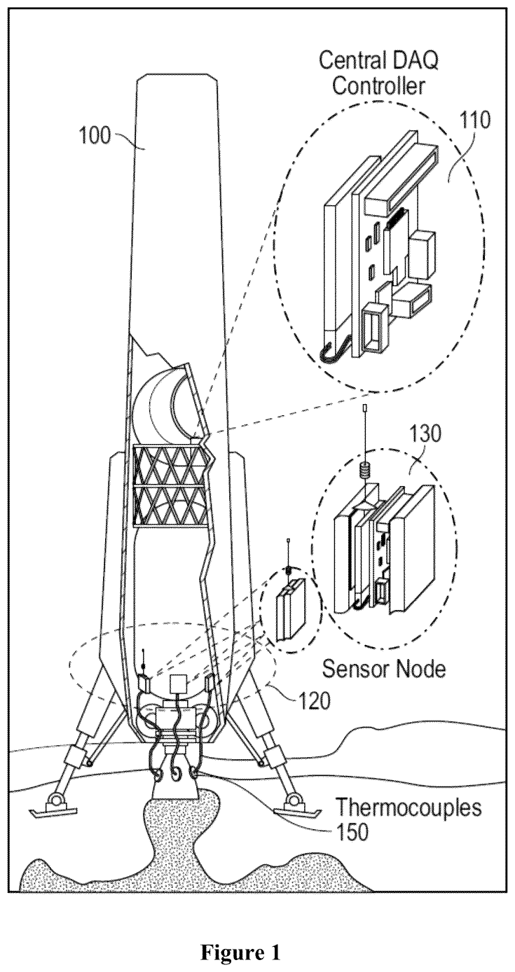

FIG. 1 illustrates an example operating environment of a wirelessly activated remote data acquisition system. Referring to FIG. 1, a spacecraft 100 can include a central DAQ controller 110 located within a cabin or bulkhead of a spacecraft 100 and an ad hoc wireless sensor system 120 including a plurality of sensor nodes 130. Sensor system 120 can be used to collect data including, but not limited to, temperatures (e.g., via thermocouples 150) and/or acceleration or orientation (via accelerometer). As part of the data acquisition functionality, the central DAQ controller 110 receives and stores the data collected by the sensor system 120.

In addition to data acquisition, the central DAQ controller 110 is configured to transmit an appropriate signal for wireless wake-up of the sensor nodes. Central DAQ controller 110 is expected to be “always on” and/or powered by system power (e.g., of the spacecraft 100). The sensor nodes 130 of the sensor system 120 include circuitry that receives the signal for wireless wake-up from a dormant/hibernation state. In this manner, portions of the electronic systems of the sensors can be completely powered down for extended periods of time while remaining in a state which will allow immediate power up on demand. Each sensor node 130 of the sensor system 120 can be battery-operated and capable of remaining in a dormant phase. The sensor nodes 130 of sensor system 120 can be transitioned back and forth between active and dormant phases. Sensor nodes 130 can be packaged in a manner that enables the sensor nodes 130 to be disposed on an outside of an environmentally protected portion of the spacecraft 100. This enables one to avoid additional penetration into the environmentally protected portions of the spacecraft 100.

As mentioned above, a similar set up of DAQ controller 110 and sensor system 120 can be implemented at remote stations that may be unoccupied or expected to be inactive for long periods of time.

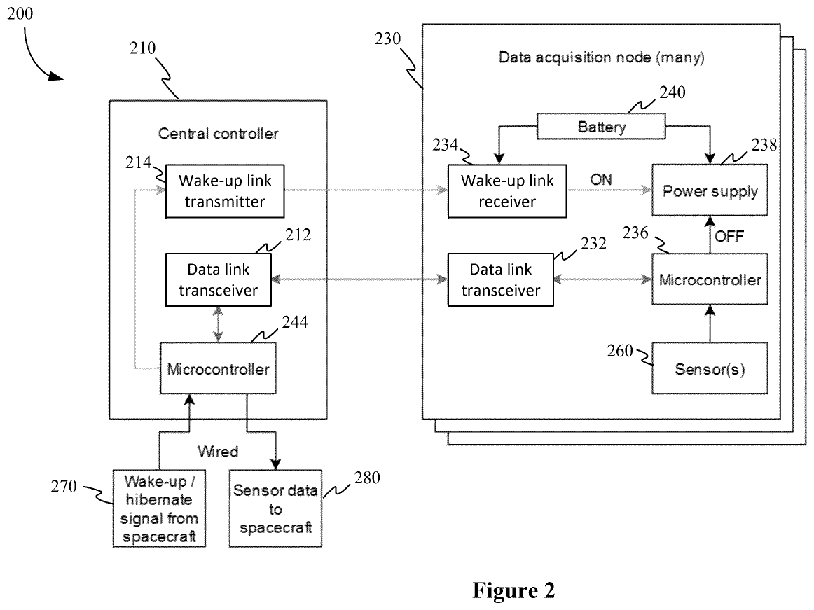

FIG. 2 shows a diagram of a wirelessly activated remote data acquisition system. Referring to FIG. 2, a wirelessly activated remote data acquisition system 200 includes a central controller 210 and a sensor system that includes a plurality of data acquisition nodes 230.

Two disparate wireless technologies are used to enable long-term hibernation of a compact, battery-operated microcontroller-based electronic device. One wireless technology enables transfer of data to and from the device (the “data link”), while the other wireless technology is used to take the device out of hibernation (the “wake-up link”). That is, the data transmission is a separate link from the wake-up link.

Accordingly, central controller 210 includes a data link transceiver 212 and a wake-up link transmitter 214; and each data acquisition node 230 includes a data link transceiver 232 and a wake-up link receiver 234. In various implementations, the data link transceiver 212 and the data link transceiver 232 are bi-directional. The data link transceivers 212, 232 can be any suitable wireless communication protocol including, but not limited to, Wi-Fi, Bluetooth, long term evolution (LTE), or long range radio (LoRa). In various implementations, the wake-up link transmitter 214 and wake-up link receiver 234 are uni-directional, where the wake-up link transmitter 214 is configured to transmit a wake up signal to the data acquisition node and the wake-up link receiver 234 is configured to receive the wake up signal from the central controller.

The wake up signal can be an ultra low power Low Frequency signal. For example, the wireless technology behind the wake-up link of the wake-up link transmitter 214 and wake-up link receiver 234 utilizes a 15-150 kHz Low Frequency (LF) carrier to transmit and receive a programmable digital wake-up pattern. The wake-up link wireless technology can be optimized for operating in a very low-power, ready-to-receive state. The power consumption in this state can be significantly lower than that of other common wireless technologies, such as Wi-Fi and Bluetooth. In this manner, it is possible to extend the life of the battery by only using the battery to power the wake-up link receiver 234 when the sensor node is in a dormant phase.

Despite its low power usage, wake-up link technology can achieve relatively long-distance transmission and reception, while reliably waking up the device almost instantaneously.

A dedicated wake-up receiver 234 can be built into each sensor device/node, constantly monitoring for the wake-up signal. The wake-up receiver 234 is coupled to a battery 240 at the data acquisition node so that the wake-up receiver 234 remains available to receive the wake-up signal while the rest of the device (e.g., processor 236 of node 230) is powered down, consuming orders of magnitude less power than when the device is fully powered on. To support the wake-up operations, node 230 includes a power supply circuit 238 triggered by the wake-up link receiver 234. Power supply circuit 238 allows the wake-up receiver 234 to power on the full device electronics (e.g., including the processor 236, data link transceiver 232, and, if needed, sensor(s) 260), and which also allows the device to later power itself down and go back into hibernation. When the receiver 234 detects the specific LF signal pattern (e.g., pulse pattern of the wake-up signal) transmitted by the central controller 210, the wake-up receiver 234 can generate an interrupt (e.g., a signal) to wake up the main processing unit (processor 236) of the sensor device.

In some cases, device/node 230 is part of an array (“data acquisition nodes”) to provide a wireless data acquisition/environmental sensor system that can be installed on spacecraft and remain in the ultra-low power hibernation state for many years before the spacecraft is ready to launch from Earth, with the system being able to rapidly transition from hibernation to actively acquiring sensor data and transmitting it wirelessly to a central collection point (e.g., with central controller 210) aboard the spacecraft. In some cases, different sensor nodes 230 of such an array utilize different wake-up patterns so that not all sensor nodes are controlled by the same signal (e.g., using address coding to target specific devices). In some cases, all sensor nodes of the array utilize the same digital wake-up pattern. The transmitted data (from the array of sensor nodes) is sent to the central controller 210 as part of a semi-live stream.

In some cases, the central controller 210 can be controlled from a hibernation state by a signal 270 from the spacecraft. In addition, sensor data 280 can be fed from the central controller 210 to the spacecraft for other systems'uses. These connections from the central controller 210 to other systems on the spacecraft can be wired.

Processor 236 can be a microcontroller or other circuitry.

Sensor(s) 260 of the nodes 230 can include type K thermocouple instruments, with acoustics, heat flux, strain gauge, etc.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A data acquisition (DAQ) system, comprising:
a central controller comprising a wake-up link transmitter and a central data link transceiver; and
a data acquisition node comprising:
a battery;
a wake-up link receiver coupled to and powered by the battery;
a power supply circuit controlled by a signal from the wake-up link receiver, the power supply circuit being coupled to the battery and the wake-up link receiver;
a processor coupled to the power supply circuit to receive power under control of the signal from the wake-up link receiver; and
a data link transceiver coupled to the processor,
wherein the processor directs the data link transceiver to transmit data from one or more sensors coupled to the processor.

2. The DAQ system of claim 1, wherein the wake-up link transmitter is uni-directional;
and wherein the wake-up link receiver is uni-directional.

3. The DAQ system of claim 2, wherein the central data link transceiver is bi-directional and wherein the data link transceiver is bi-directional.

4. The DAQ system of claim 1, wherein the wake-up link transmitter and the wake-up link receiver utilize a 15-150 kHz Low Frequency (LF) carrier to respectively transmit and receive a programmable digital wake-up pattern.

5. The DAQ system of claim 1, wherein the data acquisition node is provided in plurality.

6. The DAQ system of claim 5, wherein the central data link transceiver is configured to receive signals transmitted by the data link transceiver of each data acquisition node.

7. A data acquisition node, comprising:
a battery;
a wake-up link receiver coupled to and powered by the battery;
a power supply circuit controlled by a signal from the wake-up link receiver, the power supply circuit being coupled to the battery and the wake-up link receiver;
a processor coupled to the power supply circuit to receive power under control of the signal from the wake-up link receiver; and
a data link transceiver coupled to the processor,
wherein the processor directs the data link transceiver to transmit data from one or more sensors coupled to the processor.

8. The data acquisition node of claim 7, wherein the wake-up link receiver is uni-directional.

9. The data acquisition node of claim 8, wherein the data link transceiver is bi-directional.

10. The data acquisition node of claim 7, comprising the one or more sensors.

11. The data acquisition node of claim 10, wherein the one or more sensors include one or more selected from the group consisting of a thermocouple, an acoustic sensor, a heat flux sensor, and a strain gauge.

12. The data acquisition node of claim 7, wherein the data acquisition node is configured for being disposed on an outside of an environmentally protected portion of a spacecraft.
